(19) United States
(12) Patent Application Publication
(10) Pub. No.: US 2006/0075989 A1
(43) Pub. Date: Apr. 13, 2006

(54) High efficiency hot gas vane actuator

(75) Inventors: Eric J. Barth, Nashville, TN (US); Michael Goldfarb, Franklin, TN (US); Kevin B. Fite, Nashville, TN (US); Bo Li, Nashville, TN (US)

Correspondence Address: Michael C. Barrett, Esq.;FULBRIGHT & JAWORSKI, L.L.P., Suite 2400, 600 Congress Avenue, Austin, TX, 78701, US

(73) Assignee: Vanderbilt University

(21) Appl. No.: 11/120,129

(22) Filed: May 2, 2005

Related U.S. Application Data
(60) Provisional application No. 60/567,110, filed on Apr. 30, 2004.

(51) Int. Cl. F02B 53/10

(52) U.S. Cl. 123/209

(57) ABSTRACT

Motors and associated methods. Representative motors include high-conversion efficiency, unidirectional or bidirectional small-scale hot gas vane motors. An injection chamber receives hot injection gases. A non-circular stator is coupled to the injection chamber, and the non-circular stator is designed for maximum expansion of the hot injection gas. A rotor is coupled to the non-circular stator and accelerates when the hot injection gas expands, resulting in a conversion of hot injection gas to rotary mechanical power.

This application claims priority to, and incorporates by reference, U.S. Provisional Patent Application Ser. No. 60/567,110 entitled, “HIGH EFFICIENCY HOT GAS VANE ACTUATOR,” which was filed on Apr. 30, 2004.

### BACKGROUND OF THE INVENTION

Aspects of this invention were made with government support by the Defense Advanced Research Projects Agency, Contract/Grant No. DAAD190110509. The government may accordingly have certain rights in this invention.

I. Field of the Invention

The present invention relates to motors. More particularly, embodiments of this invention describe methods and systems for small-scale, unidirectional or bidirectional hot gas vane motors.

II. Description of Related Art

The state of the art self-powered, small-scale motors includes, either battery-powered electric motors or hydrocarbon-fueled internal-combustion-engines. The battery-powered electric motors consist of lithium variant (e.g., lithium thionyl chloride) or zinc variant (e.g., nickel zinc) batteries, which power rare earth magnet (e.g., neodymium) brushed or brushless DC or AC motors. Though the approach provides on-demand start/stop, bi-directional operation, high-bandwidth, and quiet operation, significant disadvantages of low power density and low energy density (relative to hydrocarbon-based systems) are detrimental. The hydrocarbon-fueled combustion engines include four-stroke, two-stroke, or turbofan engines. These engines provide good power and energy densities, but do not provide an on-demand start/stop operation (i.e., start/stop generally requires an auxiliary starter system) and bidirectional operation. Further, the hydrocarbon-fueled combustion engines are limited to a small range of torque/speed combinations, are low-bandwidth devices, and are extremely loud.

Scaling turbine engines have been considered to overcome deficiencies of battery-powered electric motors and hydrocarbon-fueled internal-combustion-engines. Turbine engines operate at a minimum characteristic speed as determined by the speed of sound at the rotor tips in order to achieve a reasonable efficiency, and thus are constrained to operate at extremely high rotational speeds, especially at the scales of interest. Further, the inordinately high speeds at small scales can lead to significant rotor vibration problems, bearing life problems, and high frictional losses.

Typical combustion-based devices may also be used as a small-scale motor. However, they lose considerable efficiency at small scales, due to flame quenching near walls, which exerts a significant influence at small scales due to the increased amount of surface area relative to volume.

Thus, there is a need for systems that provide comparable energy densities to hydrocarbon-based engines, but also include significantly high power density (relative to two and four-stroke engines), on-demand start/stop, bi-directional operation, high-bandwidth operation, large dynamic range (i.e., torque/speed range), and quiet operation. Further, there is a need for a system that is scalable, particularly for sub-horsepower applications.

The referenced shortcomings are not intended to be exhaustive, but rather are among many that tend to impair the effectiveness of previously known techniques concerning motors; however, those mentioned here are sufficient to demonstrate that the methodologies appearing in the art have not been altogether satisfactory and that a significant need exists for the techniques described and claimed in this disclosure.

### SUMMARY OF THE INVENTION

A hot gas vane motor made and used according to the present disclosure may overcome or address some or all the limitations discussed above. Embodiments of this disclosure utilize the injection of a monopropellant or bipropellant that provides an advantageous power and energy density. Scalable hot gas vane motors described here also have unidirectional and/or bidirectional capabilities.

In one embodiment, a motor is provided. The motor includes an injection chamber for receiving hot injection gases, a non-circular stator coupled to the injection chamber, the non-circular stator providing for a substantially complete expansion of the hot injection gases, and a rotor coupled to the non-circular stator, the rotor accelerating upon the expansion of the hot injection gases, resulting in a conversion of hot injection gases to rotary mechanical power.

In another embodiment, a motor includes an injection chamber for receiving hot injection gases, a non-circular stator coupled to the injection chamber, the non-circular stator providing for a substantially complete expansion of the hot injection gases, at least one end cap coupled to the non-circular stator, the end cap including a plurality of exhaust ports, and a spool valve coupled to the plurality of exhaust ports, the spool valve routing exhaust to the plurality of exhaust ports.

In another embodiment, a method is disclosed. A first injection port is opened, providing a stream of hot gas. The method also provides a motor that includes a non-circular stator for converting the stream of hot gases into rotary mechanical power and a plurality of exhaust ports for removing exhaust from the non-circular stator. Further, the method includes the step of removing exhaust from the non-circular motor.

In another embodiment, a motor includes an injection chamber, an asymmetric, non-circular stator, and a rotor. The injection chamber receives injection gas. The stator is coupled to the injection chamber and is shaped to achieve a substantially complete expansion of the injection gas. The rotor is coupled to the stator and is configured to accelerate upon the expansion of the injection gas to generate rotary mechanical power. The rotor may be positioned off-center with respect to the non-circular stator. The motor may also include an external injection valve and catalyst pack coupled to the injection chamber. The injection chamber may receive injection gas from catalytic decomposition of a monopropellant. The injection chamber may receive injection gas from a catalytic decomposition of a bipropellant. The motor may also include an end cap coupled to the stator, and the end cap may include a plurality of exhaust ports for releasing compressed gas. The motor may have various diameters—in one embodiment, a diameter between approximately 5 cm and 50 cm and, more particularly, between approximately 10 cm and 50 cm. The motor may be a unidirectional, hot gas vane motor. The motor may be a bidirectional, hot gas vane motor including a spool valve that is moveable such that it routes exhaust through a plurality of exhaust ports in an end cap.

In another embodiment, a motor includes an injection chamber, an asymmetric, non-circular stator, an end cap, and a spool valve. The injection chamber receives injection gas. The stator is coupled to the injection chamber and is shaped to achieve a substantially complete expansion of the hot injection gas. The end cap is coupled to the stator and includes a plurality of exhaust ports. The spool valve is coupled to the plurality of exhaust ports and routes exhaust to the plurality of exhaust ports.

In another embodiment, a method is provided. Gas is injected into an injection chamber through an injection port. A of a rotor is rotated in a forward direction relative to an asymmetric, non-circular stator with the injected gas. Exhaust gas is removed using exhaust ports that are positioned relative to the injection port so that substantially no compression of gas occurs during a return portion of the rotation. The method may also include decomposing a monopropellant to provide gas to be injected into the injection chamber. The method may also include decomposing a bipropellant to provide gas to be injected into the injection chamber. The injection port may include a forward injection port, and the method may also include closing the forward injection port and opening a reverse injection port for rotating a vane of the rotor in a reverse direction. The exhaust ports may include forward direction exhaust ports, and the method further may also include closing the forward direction exhaust ports and opening a reverse direction exhaust ports. The method may also include controlling the opening and closing of forward and reverse direction exhaust ports using a spool valve.

The terms “a” and “an” are defined as one or more unless this disclosure explicitly requires otherwise.

The term “approximately” and its variations are defined as being close to as understood by one of ordinary skill in the art, and in one non-limiting embodiment the terms are defined to be within 10%, preferably within 5%, more preferably within 1%, and most preferably within 0.5%. The term “substantially” and its variations are defined as being largely but not necessarily wholly what is specified as understood by one of ordinary skill in the art, and in one-non and in one non-limiting embodiment the substantially refers to ranges within 10%, preferably within 5%, more preferably within 1%, and most preferably within 0.5% of what is specified.

The term “high pressure” is defined according to its ordinary meaning to those having ordinary skill in the art, within its given context in this disclosure. In one non-limiting embodiment, high pressure refers to a pressure higher than atmospheric pressure and resulting from, e.g., a combustion event or reaction. For example, high pressure may be generated by a catalytic decomposition of a monopropellant and/or bipropellant

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

The term “coupled,” as used herein, is defined as connected, although not necessarily directly, and not necessarily mechanically.

Other features and associated advantages will become apparent with reference to the following detailed description of specific, example embodiments in connection with the accompanying drawings.

### BRIEF DESCRIPTION OF THE DRAWINGS

The following drawings form part of the present specification and are included to further demonstrate certain aspects of the invention. The drawings do not limit the invention but simply offer examples.

FIG. 1 shows a hot gas vane motor according to embodiments of the disclosure.

FIG. 2 shows a portion of a hot gas vane motor according to embodiments of the disclosure. The hot gas vane motor is shown with the inlet faceplate and catalyst pack removed.

FIG. 3 shows a cross-sectional view of a hot gas vane motor and a non-circular stator according to embodiments of the disclosure. The distribution of exhaust porting is also shown.

FIG. 4A shows a faceplate with injection ports according to embodiments of the disclosure.

FIG. 4B shows a non-circular stator with injection and exhaust ports according to embodiments of the disclosure.

FIG. 5 shows a front end view of a bidirectional hot gas vane motor according to embodiments of the disclosure.

FIG. 6 shows a back end view of a bidirectional hot gas vane motor according to embodiments of the disclosure.

FIG. 7A show a cross-sectional view of a bidirectional hot gas vane motor according to embodiments of the disclosure. Forward and reverse injection ports and exhaust ports are shown.

FIG. 7B show a faceplate with injection ports according to embodiments of the disclosure.

FIG. 8A show a faceplate with injection and exhaust ports according to embodiments of the disclosure. The routing of injection ports and exhaust ports from stator to spool valve are shown.

FIG. 8B show a faceplate with a spool valve according to embodiments of the disclosure.

### DESCRIPTION OF ILLUSTRATIVE EMBODIMENTS

The description below is directed to specific embodiments, which serve as examples only. Description of these particular examples should not be imported into the claims as extra limitations because the claims themselves define the legal scope of the invention. With the benefit of the present disclosure, those having ordinary skill in the art will comprehend that techniques claimed and described here may be modified and applied to a number of additional, different applications, achieving the same or a similar result. The attached claims cover all such modifications that fall within the scope and spirit of this disclosure.

Embodiments of this disclosure involve small-scale, hot gas vane motors (HGVMs), which efficiently convert a high-pressure stream of hot gas into rotary mechanical power. In one embodiment, an HGVM may be approximately 5 cm in diameter, although an HGVM may range up to 50 cm in diameter as well. Other sizes may be used, as those having ordinary skill in the art will recognize having the benefit of this disclosure.

In one embodiment, a high-pressure stream of hot gas is produced by a catalytic decomposition of a monopropellant. Alternatively, a high-pressure stream of hot gas may be produced by a catalytic decomposition of a bipropellant (e.g., hypergolically with an appropriate bipropellant). As such, the HGVM can be considered an external combustion engine, since an exothermic chemical reaction takes place before the hot reaction products reach the engine inlet. Unlike an internal-combustion two- or four-stroke engine, the HGVM may be configured as a continuous reaction device having a high power density. Further, the efficiency of the HGVM is independent of rotational speed (i.e., it depends primarily on expansion ratio, which is independent of speed in designs illustrated here), and therefore, the operational efficiency may be maintained across the entire speed range from stall to maximum speed.

Unidirectional HGVM:

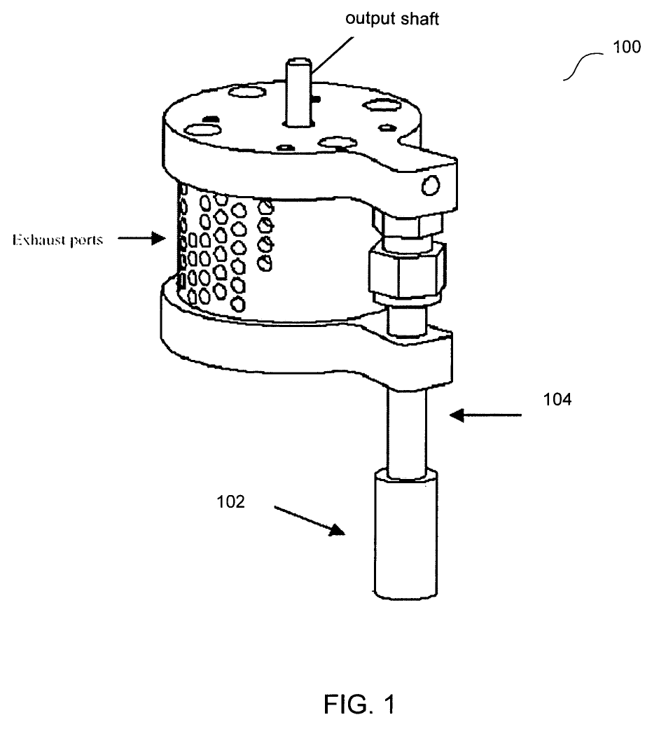

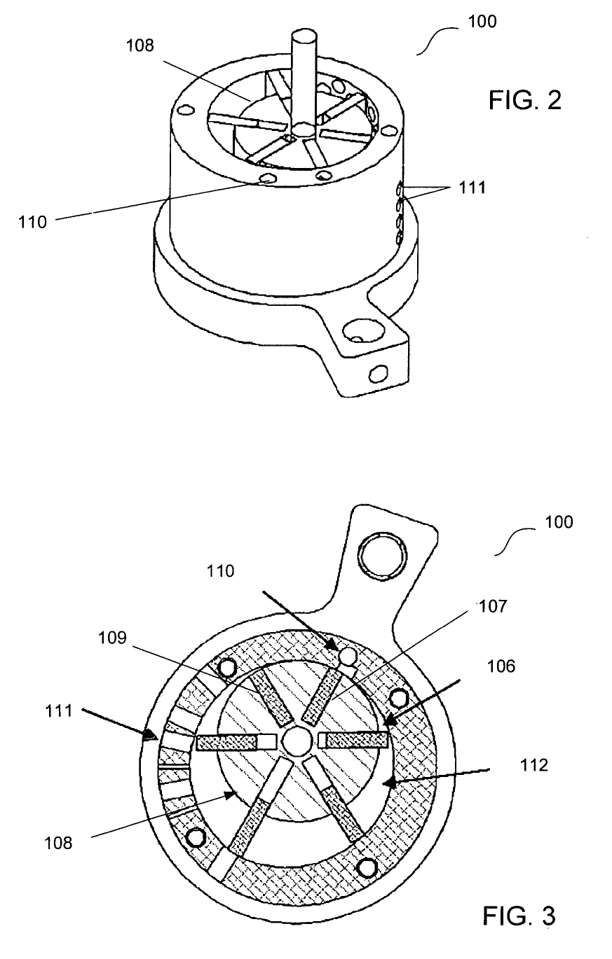

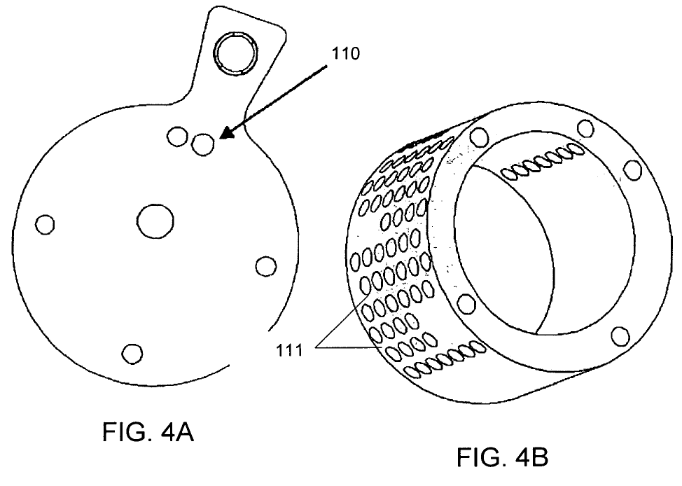

In one embodiment, a HGVM may operate in a unidirectional manner, as shown in FIGS. 1-4. The HGVM may be a vane motor, which may incorporate unique geometry such as, but not limited to, any non-circular geometries including oval, square, rectangle, pentagonal, hexagonal, octagonal, and the like and port configurations that enable conversion efficiencies higher than conventional vane motor approaches by providing for high expansion ratios while eliminating or severely reducing intake compression.

The energy conversion process may described with reference to FIGS. 1-4 by following a discrete mass of hot gas through the motor. Referring to FIG. 1, a high-pressure stream of hot gas may be injected through injection valve 102 and may undergo a catalytic reaction in the catalyst pack 104, external to the HGVM 100. The catalytic reaction provides high-pressure hot gas at the injection chamber 106 of the HGVM 100, as illustrated in FIG. 3. The injection chamber 106 may be pressurized at a substantially constant pressure (e.g., a constant pressure process). Since the leading vane 107 provides a greater exposed surface area and moment arm relative to the rotor 108 than does the trailing vane 109, a net torque is produced in the forward direction, and (assuming the rotor is not constrained otherwise) the rotor 108 will move in the forward direction. Once the trailing vane 109 of the injection chamber 106 moves past the injection port 110, the chamber becomes a working chamber 112 and the chamber behind it becomes the inlet chamber. The working chamber 112 has a fixed mass of hot gas, which performs work on the rotor as the hot gas, i.e., the chamber volume expands. The amount of work that can be extracted from the hot gas is a function of the expansion ratio, where the ratio of the final volume of the working chamber (immediately prior to exhaust) is relative to the initial volume of the working chamber (immediately after injection).

In a conventional vane motor, the stator is of the motor is fabricated with a circular profile. As illustrated in FIGS. 1-4, the profile of the stator is non-circular and may have a shape selected to provide a maximum expansion ratio, thus extracting a maximum amount of work from the hot gas and also maximizing the conversion efficiency. Additionally, the exhaust ports 111 are positioned relative to injection ports 110 so that substantially no compression of remaining gas occurs during the return portion of the rotation.

Bi-Directional HGVM:

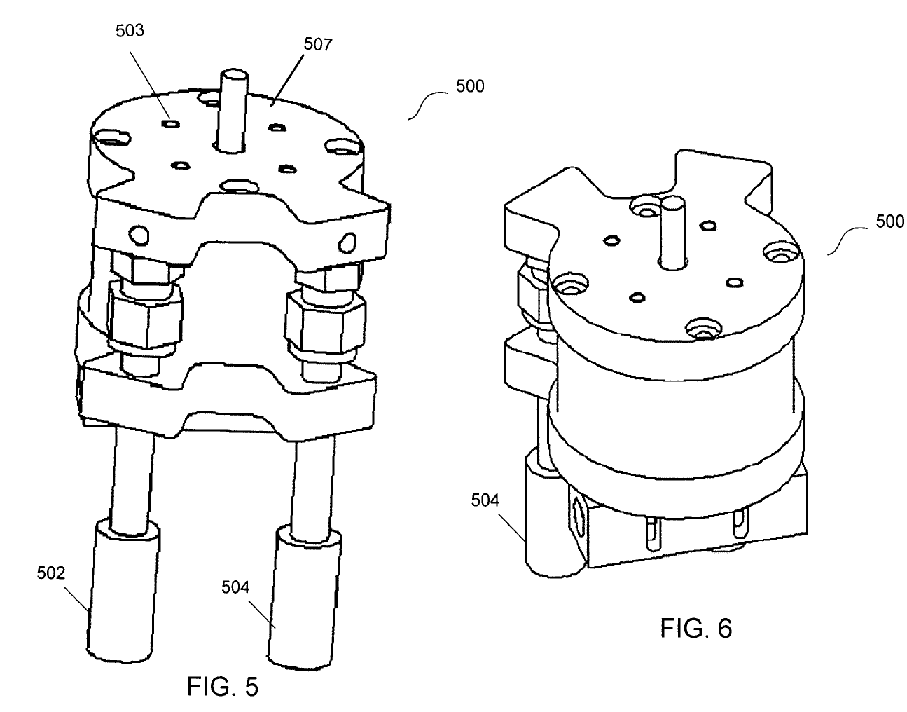

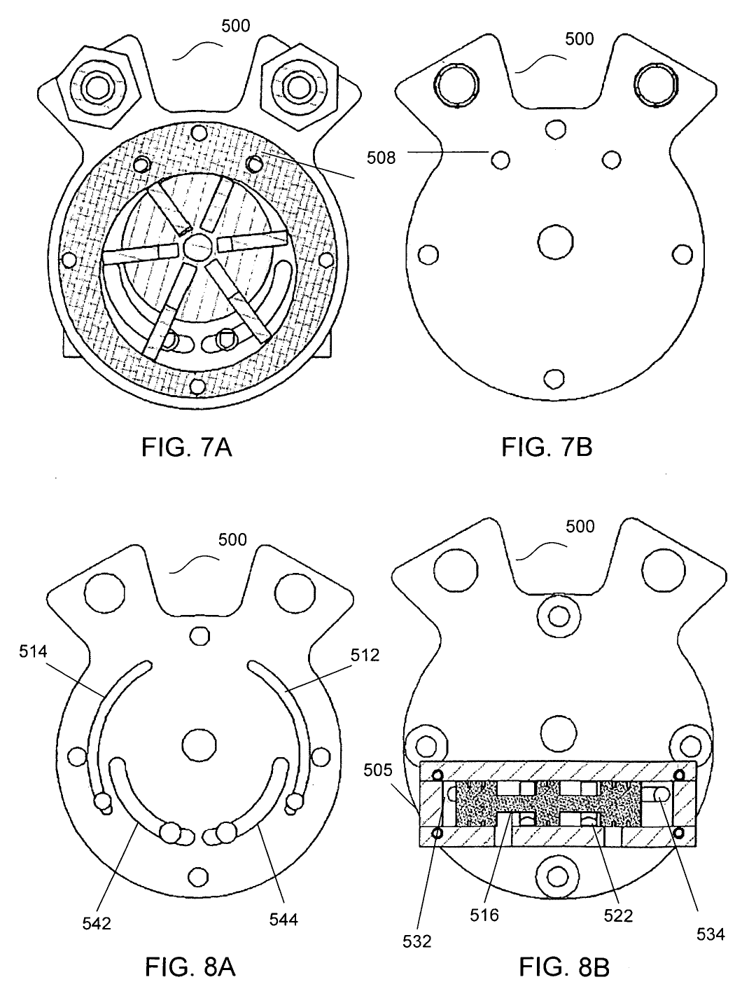

Obtaining a high conversion efficiency relies, in part, on maximizing the expansion ratio, which is enabled in embodiments of this disclosure by selecting a stator shape that does so, e.g., a non-circular shape designed to yield a beneficial expansion ratio. In a design with a sufficient number of vanes, maximizing the expansion ratio requires an asymmetric stator shape (i.e., more of the rotation is used for expansion, less for exhaust). A high efficiency can still be achieved with a symmetric stator shape, especially with an increased number of rotor vanes. A symmetric rotor shape would provide similar expansion ratios in both directions, but bi-directional operation in conventional motors would still be prevented by an overlap of the exhaust ports on one side and working chambers on the other. In order to circumvent this issue and other issues, a bi-directional HGVM (BDHGVM) may be designed, as described in the non-limiting embodiments here, that exhausts through an end cap (rather than through the stator) and routes both exhaust ports through a pilot-operated spool valve, which closes off the set of exhaust ports on the injection side of the stator. A suitable, example BDHGVM is shown in FIGS. 5-8.

Again, the stator shape may directly affect the expansion ratio of hot gases and conversion efficiency. In one embodiment, a BDHGVM system 500 includes exhaust ports 503 through the end cap 507, rather than through the stator, and routes exhaust ports through a pilot-operated spool valve 505, which closes off exhaust ports 516 on the injection side of the stator, as illustrated in FIGS. 5-8. To operate the BDHGVM 500 in a forward direction, the forward injection valve 502 may be opened, which initiates a bipropellant reaction and causes high-pressure hot gas to flow into both the forward injection port 512 and the forward pilot side of spool valve 522. The high-pressure gas in the forward pilot valve chamber 532 forces the spool to close off the reverse direction exhaust ports 544 and open the forward direction exhaust ports 542, at which point the BDHGVM operates similarly to the unidirectional HGVM.

To operate in reverse, the forward injection valve 502 may be closed and the reverse injection valve 504 may be opened, which initiates a bipropellant reaction and causes high-pressure hot gas to flow into both the reverse injection port 514 and the reverse pilot 534 side of spool valve 505. The latter forces the spool to the other side of the valve, which closes the forward direction exhaust ports 542 and opens the reverse direction exhaust ports 544, in which case the BDHGVM operates similarly to the unidirectional HGVM, but with the opposite direction of rotation relative to forward operation.

### EXAMPLES

Specific embodiments will now be further described by the following, nonlimiting examples. Examples should not be construed as limiting the scope of the invention.

A high-pressure hot gas source is provided by a bipropellant combination of hydrogen peroxide and the hydrocarbon fuel JP-8, e.g., kerosene. The hydrogen peroxide is metered through a catalyst pack to produce a superheated oxygenated steam. The temperature of the oxygenated steam is sufficient to hypergolically upon contact, without additional activation energy, combust JP-8, which is sprayed into the stream of hot peroxide reaction products.

Though the lower heating value of the bipropellant combination is approximately six times less than the lower heating value of pure JP-8, i.e., approximately 7 MJ/kg for the bipropellant versus approximately 43 MJ/kg for the JP-8, the enhanced efficiency of the HGVM is approximately six times that of a small-scale two-stroke internal combustion engine. For example, the HGVM has approximately 50% efficiency relative to approximately 8% for a sub-horsepower two-stroke engine. As such, the HGVM exhibits an output energy density equivalent to state of the art small-scale hydrocarbon engines, but importantly provides all the stop/start and low noise advantages of battery powered electric motors. Additionally, due to the fact that the HGVM is a continuous reaction device, the HGVM provides an order of magnitude increase in power density relative to small four-stroke internal combustion engines. Also, the HGVM relies on expansion of the reaction products for efficient energy conversion (rather than kinetic energy), and therefore does not require a fixed high rotor speed for efficient conversion, unlike the turbine engine. Rather, the HGVM can achieve high conversion efficiency regardless of speed and can therefore operate between stall condition and full speed. Since the flame and/or cycle stability is not an issue, the motor can be stopped and started by simply turning off or on the injection valves.

TABLE 1

| | | | Size | | Power |
|---|---|---|---|---|---|
| | | Mass | L × W × H | Power | Density |
| Make/Model | Type | (kg) | (cm) | (W) | (W/kg) |
| Honda GX22 | 4-stroke | 3.3 | 20 × 24 × 24 | 742 | 225 |
| | any position | | | | |
| Honda GX31 | 4-stroke | 3.4 | 20 × 24 × 24 | 1120 | 328 |
| | any position | | | | |
| Honda G100 | 4-stroke | 8.5 | 26 × 26 × 33 | 1650 | 194 |
| HGVM | Unidirectional | 1.2 | 5 × 5 × 7 | 3500 | 3000 |

Table 1 compares the power density of a peroxide/JP-8 embodiment of the HGVM to commercially-available, state-of-the-art four-stroke internal combustion engines. The peroxide/JP-8 HGVM in this example is approximately 5 cm in diameter and 7 cm long and constructed from Inconel alloy, with a total mass of approximately 1.2 kg. Such an HGVM would be capable of producing approximately 3.5 kW, which results in a power density of 3 kW/kg. Further, since the catalysis does not degrade at smaller scales, the HGVM may be scaled to a fraction of the noted size, and would be expected to provide a similar power density (e.g., a 500 W motor would weigh approximately 200 g).

With the benefit of the present disclosure, those having ordinary skill in the art will recognize that techniques claimed here and described above may be modified and applied to a number of additional, different applications, achieving the same or a similar result. The attached claims cover all such modifications that fall within the scope and spirit of this disclosure.

### REFERENCES

Each of the following references is incorporated by reference.

U.S. Pat. No. 3,981,647

U.S. Pat. No. 4,672,813

U.S. Pat. No. 5,947,712

U.S. Pat. No. 6,106,255

1. A motor comprising:
an injection chamber for receiving injection gas;
an asymmetric, non-circular stator coupled to the injection chamber, the stator shaped to achieve a substantially complete expansion of the injection gas; and
a rotor coupled to the stator, the rotor configured to accelerate upon the expansion of the injection gas to generate rotary mechanical power.

2. The motor of claim 1, the rotor positioned off-center with respect to the non-circular stator.

3. The motor of claim 1, further comprising an external injection valve and catalyst pack coupled to the injection chamber.

4. The motor of claim 3, the injection chamber receiving injection gas from catalytic decomposition of a monopropellant.

5. The motor of claim 3, the injection chamber receiving injection gas from a catalytic decomposition of a bipropellant.

6. The motor of claim 1, further comprising an end cap coupled to the stator, the end cap including a plurality of exhaust ports for releasing compressed gas.

7. The motor of claim 1, the motor having a diameter between approximately 5 cm and 50 cm.

8. The motor of claim 7, the motor having a diameter between approximately 10 cm and 50 cm

9. The motor of claim 1, where the motor is a unidirectional, hot gas vane motor.

10. The motor of claim 1, where the motor is a bidirectional, hot gas vane motor comprising a spool valve operably moveable to route exhaust through a plurality of exhaust ports in an end cap.

11. A motor comprising:
an injection chamber for receiving injection gas;
an asymmetric, non-circular stator coupled to the injection chamber, the stator shaped to achieve a substantially complete expansion of the injection gas;
an end cap coupled to the stator, the end cap including a plurality of exhaust ports; and
a spool valve coupled to the plurality of exhaust ports, the spool valve routing exhaust to the plurality of exhaust ports.

12. A method, comprising:
injecting gas into an injection chamber through an injection port;
rotating a vane of a rotor in a forward direction relative to an asymmetric, non-circular stator with the injected gas; and
removing exhaust gas using exhaust ports that are positioned relative to the injection port so that substantially no compression of gas occurs during a return portion of the rotation.

13. The method of claim 12, further comprising decomposing a monopropellant to provide gas to be injected into the injection chamber.

14. The method of claim 12, further comprising decomposing a bipropellant to provide gas to be injected into the injection chamber.

15. The method of claim 12, where the injection port comprises a forward injection port, and where the method further comprises closing the forward injection port and opening a reverse injection port for rotating a vane of the rotor in a reverse direction.

16. The method of claim 12, where the exhaust ports comprises forward direction exhaust ports, and where the method further comprises closing the forward direction exhaust ports and opening a reverse direction exhaust ports.

17. The method of claim 16, further comprising controlling the opening and closing of forward and reverse direction exhaust ports using a spool valve.
